(19) United States
(12) Patent Application Publication
(10) Pub. No.: US 2011/0244417 A1
(43) Pub. Date: Oct. 6, 2011

(54) DEVICE FOR SELECTIVE TARGETING OF A SUBSTANCE TO A BODY PART

(76) Inventors: Kenneth HILSEN, Saddle River, NJ (US); Jiogy Grundy, Fairview, NJ (US); John Kallis, Upper Saddle River, NJ (US); Jorge M. Cervantes Grundy, Fairview, NJ (US)

(21) Appl. No.: 13/078,175

(22) Filed: Apr. 1, 2011

Related U.S. Application Data
(60) Provisional application No. 61/341,793, filed on Apr. 5, 2010.

(51) Int. Cl. A61C 3/00

(52) U.S. Cl. 433/75

(57) ABSTRACT

The current device and method provides an apparatus for targeting a substance to a patient, such as a dental patient. The apparatus includes a support member including engagement surfaces for engaging portions of a site to which the substance is to be administered. A rotating means is coupled to the support member and a guide is coupled to the rotating means for guiding a substance delivery device into a predetermined position in the patient's body. The rotating means provides pivotal and rotational adjustment of the guide.

### CROSS REFERENCE TO RELATED APPLICATIONS

This application claims priority under 35 U.S.C. 119(e) to U.S. Provisional Application No. 61/341,793, filed Apr. 5, 2010, which is incorporated herein by reference.

### FIELD OF THE INVENTION

The present invention relates to medical devices. More specifically, the present invention relates to a device for targeted administrations of a substance, such as a drug.

### BACKGROUND OF THE INVENTION

Many physicians, dentists, and other health care providers have some degree of difficulty in locating the specific site to which a substance, such as a drug or anesthetic, should be administered.

A classic situation is that of finding the inferior alveolar nerve in the mouth when administering anesthesia. “The inferior alveolar nerve block (IANB), commonly (but inaccurately) referred to as the mandibular nerve block, is the most frequently used and possibly the most important injection technique in dentistry. Unfortunately it also proves to be the most frustrating, with the highest percentage of clinical failures (approximately 15% to 20%) even when properly administered.” See “Handbook of Local Anesthesia” by Stanley Malamed, DDS. Consequently, the dentist must try to locate the nerve repeatedly until he or she has successfully administrated anesthesia. Occasionally, a dentist will never be able to successfully deliver the anesthesia and consequently the patient will have to endure a painful dental treatment. This can occur once the dentist has infiltrated the maximum anesthetic dosage tolerated by the patient without having cardiovascular or related problems. During this painful treatment, the quality of the service will not be as good as when the anesthesia is affecting the surrounding tissue, because the patient will be moving. Psychologically, the absence of anesthesia creates fear for that patient throughout the dental treatment as well as in future visits.

Earlier inventions tried reducing the chances of movement by the dentist. See, e.g., U.S. Pat. No. 5,171,225 (Sterrett 1992), which attempts to eliminate the risk of missing the inferior alveolar nerve. While this reference provides a more secure process for administrating anesthesia, its method of guidance involves applying pressure against the tissue in the mouth, which adds discomfort to the patient. In addition, it lacks a system which displays and saves its position, making the dentist unable to deliver quicker treatments on frequent use.

### SUMMARY OF THE DISCLOSURE

The current device and method provides an apparatus for targeting a substance to a patient, such as a dental patient. The apparatus includes a support member including engagement surfaces for engaging portions of a site to which the substance is to be administered. A rotating means is coupled to the support member and a guide is coupled to the rotating means for guiding a substance delivery device into a predetermined position in the patient's body. The rotating means provides pivotal and rotational adjustment of the guide.

As adapted for dentistry, the apparatus includes a bite block including an upper and a lower engagement surface for engaging the patient's upper and lower teeth on a first side of the mouth. A rotating means is coupled to the bite block and a guide is coupled to the rotating means for guiding a needle into a predetermined position in the patient's mouth. The rotating means provides pivotal and rotational adjustment of the guide.

The present invention includes a method for targeting a substance to patient. As adapted for dentistry, a bite block is engaged with the patient's upper and lower teeth on a first side of the mouth. A rotating means coupled to the bite block is adjusted. A substance delivery device is inserted into a guide coupled to the rotating means for delivering the substance into a predetermined position in the patient's mouth, wherein the rotating means provides pivotal and rotational adjustment of the guide. After the substance has been delivered, a user can record the position of the rotating means for future reference. For example, the position can be recorded in a patient's chart.

### BRIEF DESCRIPTION OF THE DRAWINGS

A more complete understanding of the present device and method can be derived by referring to the detailed description when considered in connection with the following illustrative figures. In the figures, like reference numbers refer to like elements or acts throughout the figures.

FIG. 1 is a right perspective view of an apparatus for targeting a substance to a patient in accordance with a first embodiment of the present invention;

FIG. 2 is a back side view of the apparatus of FIG. 1;

FIG. 3 is a right side view of the apparatus of FIG. 1 as positioned and used in a patient's mouth;

FIG. 4 is an exploded view of the apparatus of FIG. 1;

FIG. 5 is a back side view of an apparatus for targeting a substance to a patient in accordance with a second embodiment of the present invention;

FIG. 6 is an exploded view of the apparatus of FIG. 5;

FIG. 7 is a right perspective view of the bite block of the apparatus of FIG. 5;

FIG. 8 is a perspective view of the rotating means and guide of the apparatus of FIG. 5;

FIG. 9 is a perspective view of the guide and associated guide arm of the apparatus of FIG. 5;

FIG. 10 is a partially exploded view of the apparatus of FIG. 5; and

FIG. 11 is a right perspective view of the apparatus of FIG. 5.

Elements and acts in the figures are illustrated for simplicity and have not necessarily been rendered according to any particular sequence or embodiment.

### DETAILED DESCRIPTION

In the following description, and for the purposes of explanation, numerous specific details are set forth in order to provide a thorough understanding of the various aspects of the current device and method. It will be understood, however, by those skilled in the relevant arts, that the present device and method can be practiced without these specific details. In other instances, known structures and devices are shown or discussed more generally in order to avoid obscuring the present device and method. In many cases, a description of the operation is sufficient to enable one to implement the various forms of the device and method. It should be noted that there are many different and alternative configurations, devices and technologies to which the disclosed device and method can be applied. The full scope of the device and method is not limited to the examples that are described below.

The present invention includes an apparatus for targeting a substance to a patient. In particular, the present apparatus can be used to accurately and precisely locate the inferior alveolar nerve and provide a guide for guiding a needle into the target position. In addition, the device can be used with any patient, wherein the target position can be adjusted and preserved for each individual patient. In a preferred embodiment, the invention provides a mechanical guiding system, which helps the dentist to guide the needle into the proper location in the patient's mouth in order to successfully administrate anesthesia in the patient every time he or she may require it. The present invention is ergonomically designed, is easy to use, and provides high accuracy. In addition, it provides results that can be reproduced every time anesthesia is necessary.

Indents are provided on a rotating means which offer a type of “click system” that can be adjusted to many positions in order to target the inferior alveolar nerve. Indicia on the device can be recorded and saved so that the proper location to effectively deliver anesthesia can be reproduced on the patient during a future visit. Also, the present device reduces the time to anesthetize the patient by eliminating unnecessary movements from the dentist. In addition, the present device eliminates or reduces errors in administration of the substance of choice, e.g., anesthesia. The present device features a window to clearly identify the current location of the needle guide. The window can include a magnifying glass to allow the indicia to be more readily distinguished. The guide is used to guide the needle to the inferior alveolar nerve in the patient's mouth and is used as the knob for adjusting the angle thereof.

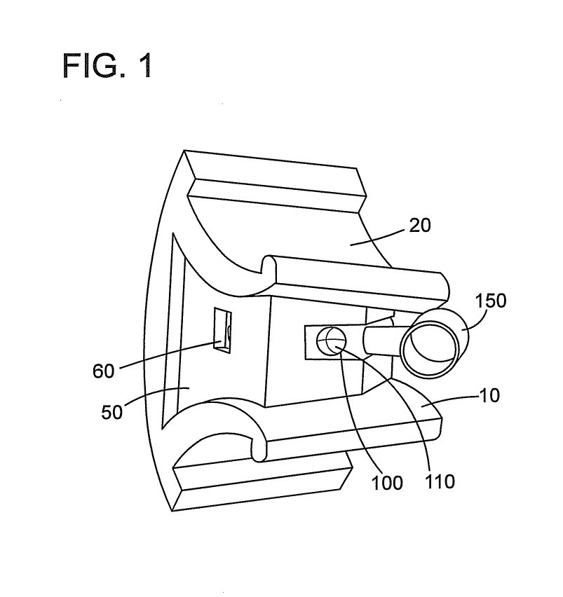

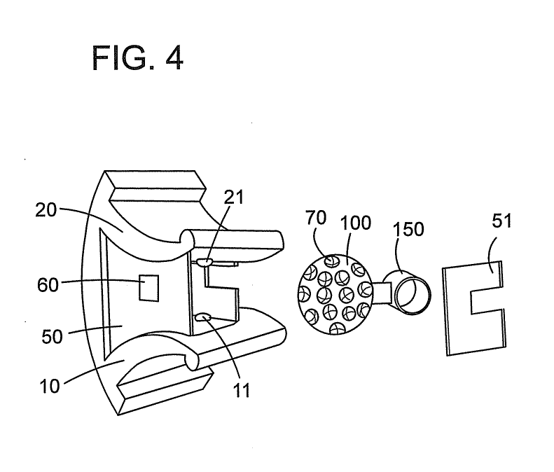

FIGS. 1-4 illustrate a first embodiment of the present invention. Referring first to FIG. 4, the guiding device includes a multi-indented sphere 100, which is housed in a cavity that is formed in the center of a bite block 50 and is secured by two spring mounds 21, 11 on the top and bottom of the cavity, respectively. The bite block 50 is a secure inter-maxillary holder with a transparent appearance.

FIG. 1 shows the guide 150, acting as a guide for the needle and a knob for changing the position of the guide, attached to the rotating means 100, which is a sphere (see FIG. 4) with a surface of indentations 110 that are labeled with its coordinate position. The magnifying glass window 60 makes all the coordinates clearly visible to the dentist so that he or she may record and save those settings for any future treatment. The sphere 100 is housed in a cavity formed in the bite block 50 that tightly surrounds the sphere 100 so that it is as stable as possible.

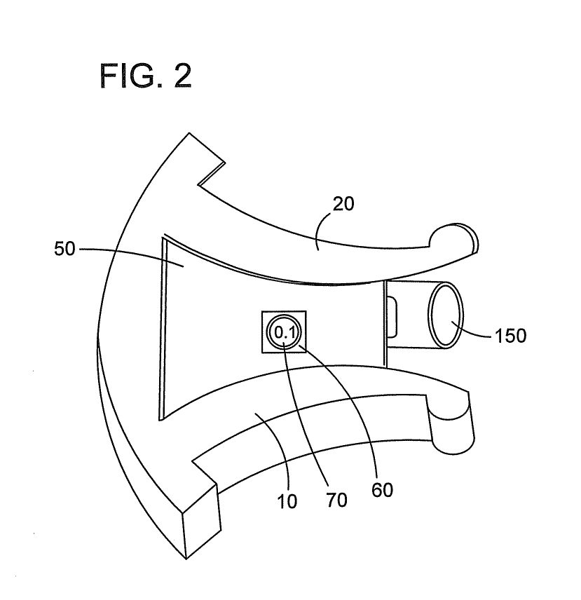

FIG. 2 depicts the interface of the sphere 100 (see FIG. 4) encased in the bite block 50. The display is magnified by the magnifying glass window 60 to clearly show the labeled coordinates 70 on each indentation of the sphere 100. To prevent any sudden movement or change in position, two spring mounds 21, 11 (see FIG. 4) are positioned on top and bottom of the sphere 100 which secure its place during the administration of anesthesia in a patient's mouth.

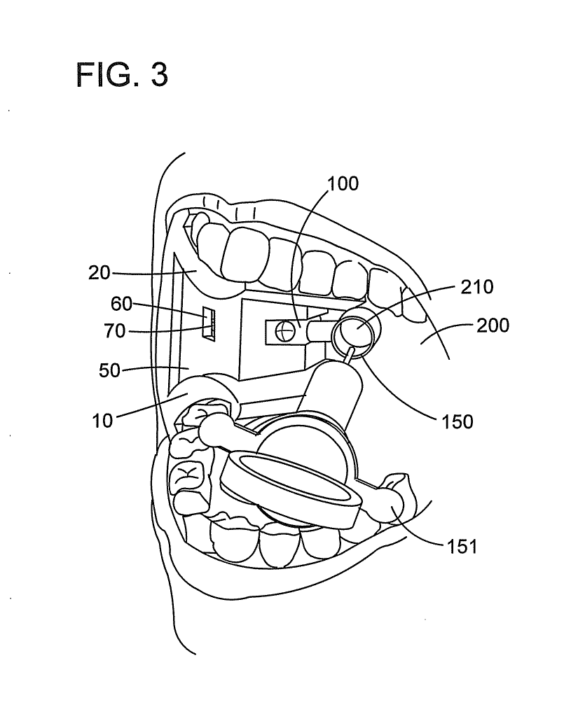

FIG. 3 depicts the present apparatus placed in the proper location in the patient's mouth 200, ready to guide the needle 152 for anesthesia. The top platform 20 of the device is supporting the maxilla while the bottom platform 10 of the device is holding the mandible in place. The needle guide 150, attached to the bite block 50, is adjusted by the user to the ideal angle so that the syringe 151 aims at the inferior alveolar nerve 210. As the user changes the position of the needle guide, the exact coordinates 70 of the final position are displayed through the magnifying glass window 60 and can be recorded by the user for future reference.

FIG. 4 depicts an exploded view of the parts of the present device according to the first embodiment of the invention. The bite block 50 of the device acts as a secure inter-maxillary holder with a cubic structure forming a cavity in the center. The top platform 20 and the bottom platform 10 have spring mounds 21 and 11 respectively placed on their centers to releasably lock the sphere 100 in place on every coordinate 70 of the sphere. In addition, the bite block 50 contains the magnifying glass window 60 and the track for the tube guide shown by the hole on the cover 51 of the cubic structure.

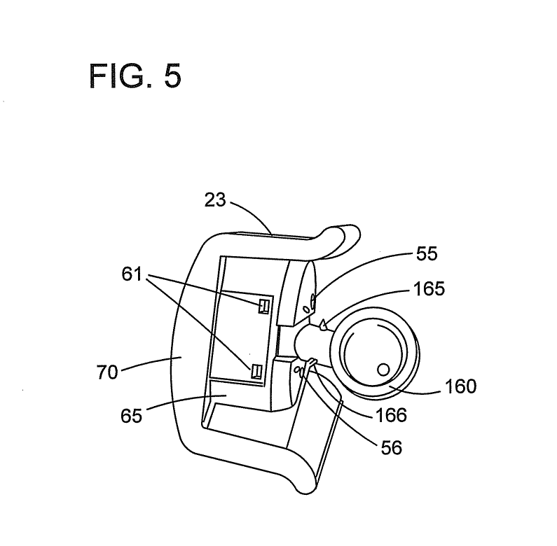

FIGS. 5-11 illustrate a second embodiment of the present invention. FIG. 5 is a back side view of an apparatus for targeting a substance to a patient in accordance with the second embodiment of the present invention.

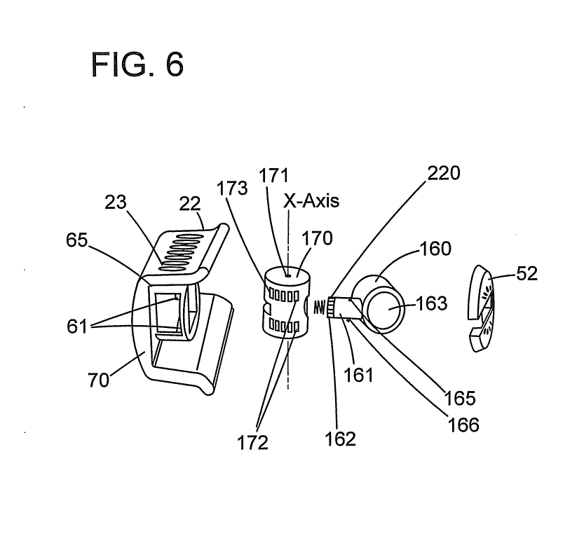

FIG. 6 is an exploded view of the apparatus of FIG. 5. The apparatus includes a bite block 70 which includes an upper engagement surface 22 and a lower engagement surface (not shown) for engaging the patient's upper and lower teeth on a first side of the mouth. At least one of the upper and the lower engagement surfaces include tabs 23 for gripping onto the patient's teeth. The apparatus includes a rotating means 170 that is coupled to the bite block. In the example illustrated, the rotating means is a cylinder that is adapted to rotate about the X-axis as shown. The cylinder includes a plurality of circumferentially positioned indicia 172 that are adapted for indicating the extent of rotation of the cylinder about the X-axis. The bite block 70 includes windows 61 for viewing the plurality of indicia 172 so that the extent of rotation of the cylinder 170 about the X-axis can be recorded. In one embodiment the indicia 172 include a plurality of colors so that the extent of rotation can be recorded by identifying and recording the color of the indicia that is visible through the windows 61. In another embodiment, the indicia 172 can be marked with numbers, letters, or other unique identifying marks. The apparatus includes a guide 160 that is coupled to the rotating means 170 via a guide arm 161. The guide arm 161 includes an upper indicator arm 165 and a lower indicator arm 166 for use when recording the extent of rotation of the guide arm about the C-axis as explained below. A spring 220 is housed within the cylinder 170 and engages with the guide arm 161 as explained below. The guide 160 is adapted for guiding a needle into a predetermined position in the patient's mouth. A cover 52 secures the rotating means 170 to the bite block 70.

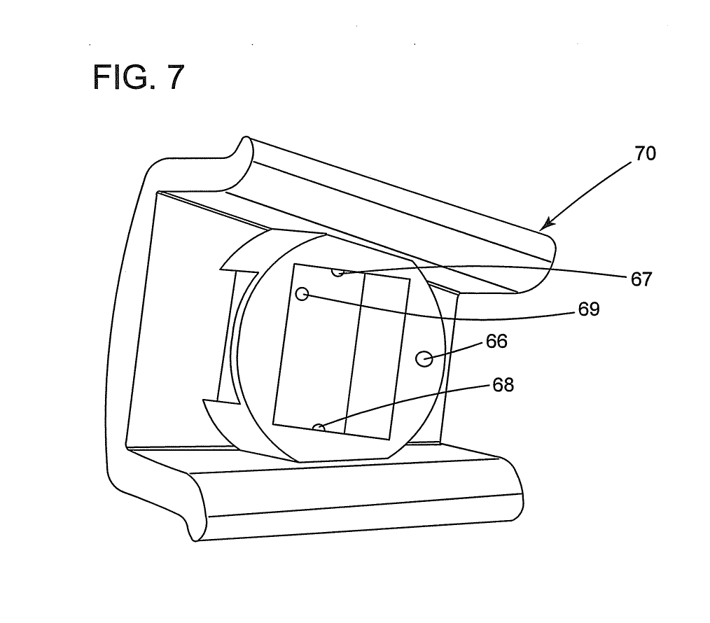

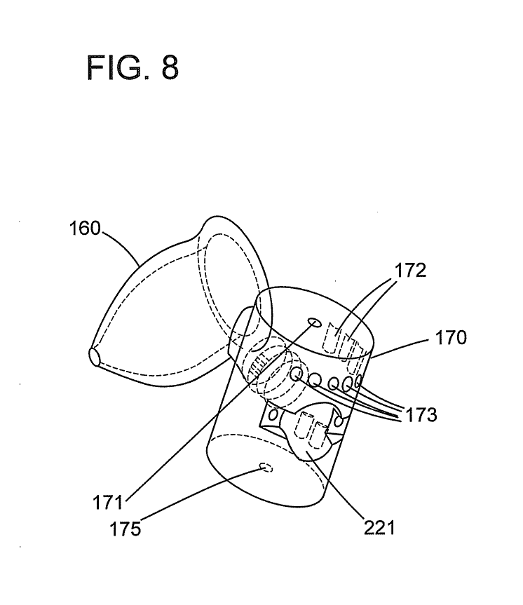

FIG. 7 is a right perspective view of the bite block of the apparatus of FIG. 5. The bite block 70 includes a plurality of surfaces that define a cavity for receiving the rotating means. Upper tab 67 and lower tab 68 are adapted to snap fit with corresponding indents on the upper and lower surface of the cylinder (see FIG. 8) for allowing rotation about the X-axis. Locking tab 69 is adapted to releasably engage with indents on the wail of the cylinder (see FIG. 8) for adjusting the extent of rotation about the X-axis.

FIG. 8 is a perspective view of the rotating means and guide of the apparatus of FIG. 5. As explained above, the cylinder 170 includes an upper indent 171 and a lower indent 175 which engage with corresponding upper and lower tabs (see FIG. 7) within the cavity of the bite block 70 for allowing rotation about the X-axis. The cylinder 170 includes a plurality of circumferentially positioned indents 173 that are adapted for releasable engagement with the locking tab 69 (see FIG. 7) for adjusting the extent of rotation of the cylinder about the X-axis. The cylinder includes an opening 221 for inserting spring 220 (see FIG. 6). The opening 221 is covered with a cap (not shown) that is secured with screws such that the spring is compressed between the inner wall of the cap and the guide arm 161 (see FIG. 6).

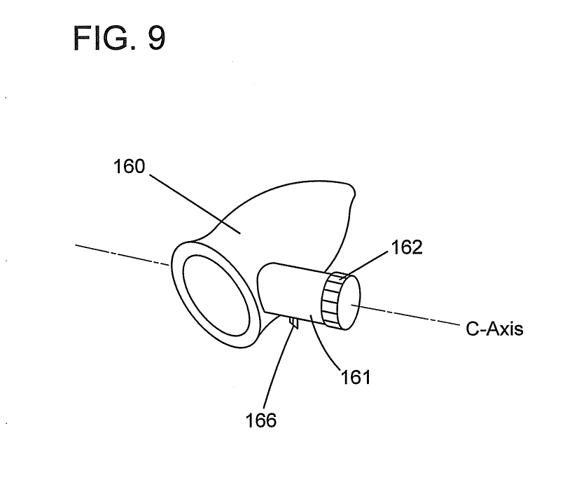

FIG. 9 is a perspective view of the guide and associated guide arm of the apparatus of FIG. 5. The first end 162 of the guide arm 161 is rotatably coupled with the cylinder 170 so that the guide arm 161 is adapted to rotate about a C-axis extending longitudinally through the guide arm. The first end 162 of the guide arm 161 includes a locking portion having a plurality of radially extending teeth (not shown) that engage with a plurality of grooves inside the cylinder (not shown). The second end of the guide arm 161 is attached with the guide 160, such as with glue or any other suitable bonding means to provide a permanent attachment.

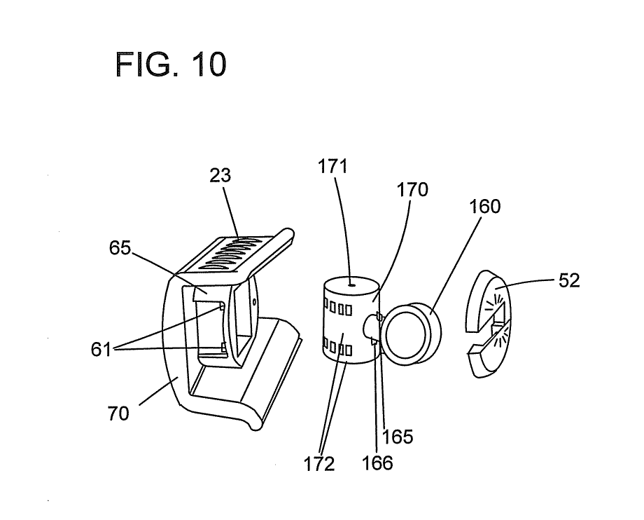

FIG. 10 is a partially exploded view of the apparatus of FIG. 5. In a locked position, the spring 220 (see FIG. 6) pushes the teeth 162 of the guide arm (see FIG. 9) against the grooves inside the cylinder (not shown) when the spring is relaxed. In an unlocked position, the spring 220 (see FIG. 6) is compressed which allows the teeth 162 of the guide arm (see FIG. 9) to be displaced into a larger cavity inside the cylinder which allows the teeth to separate from the grooves inside the cylinder (not shown) to permit rotation of the guide arm about the C-axis.

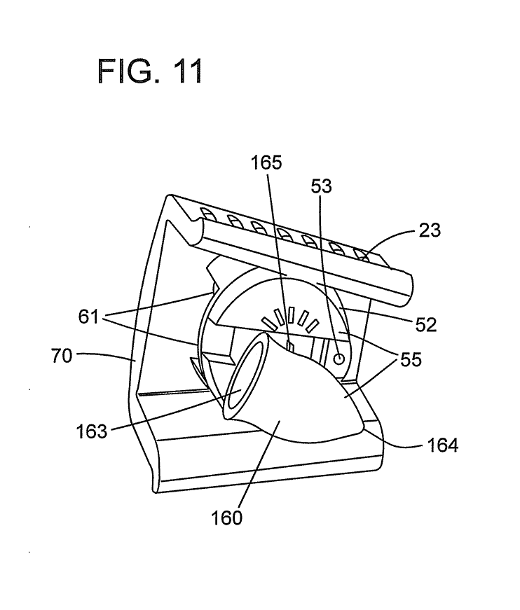

FIG. 11 is a right perspective view of the apparatus of FIG. 5. The guide 160 includes a tapered inner surface having a generally conical profile and providing a guide opening 163 and a needle outlet opening 164 for the needle (not shown) to exit from the guide. The cover 52 is attached to the bite block 70 with a screw 53 that is received by a threaded opening 66 (see FIG. 7) in the bite block. The cover 52 includes a plurality of circumferentially spaced indicia 55 for use when recording the extent of rotation of the guide arm about the C-axis by recording the position of the upper indicator arm 165 in relation to the indicia 55. When the device is used on the other side of the patient's mouth, the extent of rotation of the guide arm about the C-axis can be identified by recording the position of the lower indicator arm in relation to the indicia on the lower portion of the cover 52 (see FIG. 6).

This invention helps the dentist to anesthetize the patient in a simple manner with high accuracy and precision. In addition, it increases the confidence of the dentist to properly deliver anesthesia to the patients and more importantly to provide the patient with the most comfortable experience possible. The nature of this invention allows the dentist to save successful results for future appointments of the same patient, particularly in complicated patients.

The apparatus and method disclosed herein can be used for targeting a substance to other body parts outside of the mouth. For example, it is frequently necessary to administer a substance such as a drug, an indicator, or anesthesia to osseous tissue, for example, a vertebrate of the spine. The artisan of ordinary skill will envision modifications of the device to permit secure positioning on the spine for targeted delivery of the substance of interest to, e.g., a spinal nerve. One can envision treatment methodologies such as bone marrow or stem cell transplant, where the device would also be useful, as modified herein.

The above disclosure is intended to be illustrative and not exhaustive. This description will suggest many modifications, variations, and alternatives may be made by ordinary skill in this art without departing from the scope of the device and method. Those familiar with the art may recognize other equivalents to the specific embodiments described herein. Accordingly, the scope of the device and method described herein is not limited to the foregoing specification.

What is claimed is:

1. An apparatus for targeting a substance to a patient comprising:
a support member including engagement surfaces for engaging portions of a site to which the substance is to be administered;
a rotating means coupled to said support member; and
a guide coupled to said rotating means for guiding a substance delivery device into a predetermined position in the patient's body,
wherein said rotating means provides pivotal and rotational adjustment of the guide.

2. The apparatus of claim 1, wherein the rotating means includes a plurality of indicia that are adapted for indicating the orientation of the guide.

3. An apparatus for targeting a substance to a patient comprising:
a bite block including an upper and a lower engagement surface for engaging the patient's upper and lower teeth on a first side of said mouth;
a rotating means coupled to said bite block; and
a guide coupled to said rotating means for guiding a needle into a predetermined position in the patient's mouth,
wherein said rotating means provides pivotal and rotational adjustment of the guide.

4. The apparatus of claim 3, wherein at least one of the upper and the lower engagement surface includes tabs for gripping onto the patient's teeth.

5. The apparatus of claim 3, wherein the bite block further includes a plurality of surfaces that define a cavity adapted for receiving the rotating means.

6. The apparatus of claim 5, wherein the rotating means is a cylinder that is adapted to rotate about an X-axis extending longitudinally through the cylinder.

7. The apparatus of claim 6,
wherein the bite block includes a locking tab extending into the cavity; and
wherein the cylinder includes a plurality of circumferentially positioned indents that are adapted for releasable engagement with the locking tab for adjusting the extent of rotation of the cylinder about the X-axis.

8. The apparatus of claim 7, wherein the cylinder includes a plurality of circumferentially positioned indicia that are adapted for indicating the extent of rotation of the cylinder about the X-axis.

9. The apparatus of claim 8, wherein the bite block includes at least one window passing into the cavity for viewing the plurality of indicia so that the extent of rotation of the cylinder about the X-axis can be recorded.

10. The apparatus of claim 3, wherein the rotating means is a sphere.

11. The apparatus of claim 3, further comprising:
a guide arm having a first end and a second end,
wherein the first end of the guide arm is rotatably coupled with the rotating means so that the guide arm is adapted to rotate about a C-axis extending longitudinally through the guide arm; and
wherein the second end of the guide arm is engaged with the guide.

12. The apparatus of claim 11, wherein the guide arm includes at least one indicator arm extending radially therefrom for recording the extent of rotation of the guide about the C-axis.

13. The apparatus of claim 11, wherein the first end of the guide arm includes a first locking portion and wherein the rotating means includes a second locking portion that is adapted to receive the first locking portion for releasably locking the guide arm relative to the rotating means to prevent rotation of the guide about the C-axis.

14. The apparatus of claim 13, wherein the first locking portion includes a plurality of radially extending teeth and wherein the second locking portion includes a plurality of grooves adapted to receive the plurality of teeth.

15. The apparatus of claim 14, further comprising a spring positioned within the rotating means,
wherein in a locked position the spring is adapted for pushing the first locking portion against the second locking portion when the spring is relaxed; and
wherein in an unlocked position the spring is compressed to separate the first locking portion from the second locking portion to permit rotation of the guide arm about the C-axis.

16. The apparatus of claim 3, wherein the guide includes a tapered inner surface having a generally conical profile and providing a needle outlet opening for the needle to exit from the guide.

17. The apparatus of claim 12, further comprising a cover for securing the rotating means to the bite block.

18. The apparatus of claim 17, wherein the cover includes a plurality of circumferentially spaced indicia for use when recording the extent of rotation of the guide arm about the C-axis by recording the position of the at least one indicator arm.

19. A method for targeting a substance to a patient comprising:
engaging a bite block with the patient's upper and lower teeth on a first side of said mouth;
adjusting a rotating means coupled to said bite block;
inserting a substance delivery device into a guide coupled to said rotating means; and
delivering the substance into a predetermined position in the patient's mouth,
wherein said rotating means provides pivotal and rotational adjustment of the guide.

20. The method of claim 19 further comprising:
after the step of delivering, recording the position of the rotating means for future reference.
